(19) United States
(12) Patent Application Publication
(10) Pub. No.: US 2024/0026252 A1
(43) Pub. Date: Jan. 25, 2024

(54) SOAP COMPOSITION COMPRISING HYDROGEL

(71) Applicant: Conopco, Inc., d/b/a UNILEVER, Englewood Cliffs, NJ (US)

(72) Inventors: Sivakumar ANANTHASUBRAMANIAN, Mumbai (IN); Prashant Popat BABAR, Palus (IN); Ganesh Ankush PAWAR, Pandharpur (IN); Anal PUSHKARNA, Mumbai (IN)

(73) Assignee: Conopco, Inc., d/b/a UNILEVER, Englewood Cliffs, NJ (US)

(21) Appl. No.: 18/038,741

(22) PCT Filed: Dec. 6, 2021
(86) PCT No.: PCT/EP2021/084330

§ 371 Date: May 25, 2023

(30) Foreign Application Priority Data
Dec. 7, 2020 (EP) 20212206.5

(51) Int. Cl. C11D 9/26; C11D 13/10; C11D 13/02; C11D 9/22

(52) U.S. Cl. CPC C11D 9/267; C11D 13/10; C11D 13/02; C11D 9/225

(57) ABSTRACT

Soap composition comprising (i) saponified fatty matter made from a fat blend comprising lauric fatty acid and saturated and unsaturated non-lauric fatty acids, the iodine value being from 44 to 58 g iodine per 100 g of said saponified fatty matter; and (ii) a hydrogel which is non-thermoreversible at 70 to 140° C. Disclosed is also a bar of soap comprising the soap composition and a process of preparing the soap composition.

### FIELD OF THE INVENTION

The present invention is in the field of saponified products, especially soap noodles and soap bars made therefrom.

### BACKGROUND OF THE INVENTION

Bars of soap bars are generally made from soap noodles, usually with 40% to 80 wt % or more of total fatty material (TFM), 10 to 35 wt % water (moisture), and additives like fillers, salts, other surfactants, and fragrances. These bars are mainly produced by mixing the noodles with the other ingredients, followed by the steps of milling, extruding and stamping.

Soap noodles are typically made from oil or fat or blends by methods commonly known in the art. One of the methods is direct saponification of oil/fat in which the oil/fat is reacted with an alkali (typically sodium hydroxide) to form glycerin and the soap base (which contains fatty acid alkali salt, e.g., fatty acid sodium salt, which is also carboxylic acid sodium salt). The soap base is the fatty-acid-alkali-salt-containing material. Thus, the material after removal of glycerin (if glycerin is to be removed) and to be further processed is an example of soap base. Another method involves neutralization of fatty acid with the alkali (e.g., NaOH) to form the soap base. In the soap-making process, the soap base can be dried and plodded into noodles or chips. As used herein, the term “soap noodles” refers to the pellets or pieces of soap (whether they be in pellet, chip, bits, or other shapes). Soap noodles are typically the result of the drying and extruding of raw soap into unit form such that the soap units or pieces can be further processed into the finished soap bars by mixing with additives, as known to those skilled in the art of soap making.

In the process of saponification, various fats (e.g., tallow, palm and/or coconut or PKO oil blends) are saponified in the presence of alkali (usually NaOH) to yield alkaline salts of fatty acids (derived from the fatty acid chains forming the glyceride) and glycerol. Glycerol is then typically extracted with brine to yield dilute fatty acid soap solution containing soap (soaps formed after saponification and before extrusion to final bar are referred to often as soap “noodles”) and aqueous phase (e.g., 70% soap and 30% aqueous phase).

The chain length of soaps depends on the fat or oil feedstock which is usually a blend. For purposes of this specification, “oil” and “fat” are used interchangeably, except where context demands otherwise. Longer chain fatty acid soaps (e.g., C₁₆ palmitic or C₁₈ stearic) are typically obtained from tallow and palm oils, and shorter chain soaps (e.g., C₁₂ lauric) may typically be obtained from, for example, coconut oil or palm kernel oil. The fatty acid soaps produced may also be saturated or unsaturated (e.g., oleic acid).

Typically, longer chain fatty acid soaps (e.g., C₁₄ to C₂₂ soaps) especially longer, saturated soaps are insoluble and do not generate enough foam upon use but they can make the foam creamier and more stable. Conversely shorter chain soaps (e.g., C₈ to C₁₂) and unsaturated soaps (e.g., oleic or linoleic acid soap) lather quickly. However, the longer chain soaps (typically saturated, although they may also contain some level of unsaturated such as oleic) are desirable to maintain structure and not dissolve as readily. Unsaturated soaps (e.g., oleic) are soluble and lather quickly, like short-chained soaps, but form a denser, creamier foam, like the longer chained soaps.

Typically, a bar which is formed by extrusion rather than cast melt process are expected to be sufficiently hard (not too mushy as to clog machinery or too non-plastic as to slow rate of production and cause cracking) so that the soaps can be extruded at a sufficiently high rate. Usually, oils or fatty acids of iodine value (IV) 30 to 43, preferably 38 to 42 are used for this purpose.

Hardness depends on iodine value of the oils which get saponified. Oils and fats which have a high average level of unsaturation are said to have high iodine value; and oils and fats which have a low average level of unsaturation are said to have low iodine value. Typically, bars made from oils with higher iodine value (more unsaturated) are softer and those made from oils with low IV value (more saturated) are harder. Iodine value is a well-known standard for measuring unsaturation and measurement of IV is well known and understood. One well known method, for example, is use of gas chromatography.

Using this method, methyl esters of the fatty acid chains in the oil are formed and analysed by gas chromatography.

An increase in the IV of oils, and corresponding that of the soaps, increases their water solubility and thereby the bars tend to become softer. In addition, an increase in the IV tends to affect the stability of the composition due to increase in the peroxide value. However, when formulation scientists want to make soap bars from high IV oils/or fatty acids, they tend to rely on electrolytes as antioxidants or certain thickening agents to increase hardness of the soap bars.

US2019284513 A1 (Unilever) discloses predominantly (>50%) soap bars made from oil or oils of defined IV, containing some amount of potassium soaps. The bars are easier to extrude and do not crack as much whilst exhibiting lower wear and mush values. By specifically saponifying oils so that 5% to 15% of potassium soap noodles are formed (as percent of total bar composition), starting oils having IV 37 can be used.

EP0537964 A1 (Unilever, 1993) discloses soap bars that contain 90 to 50% fatty acid soaps obtained from tallow (non-lauric fats) and 10 to 50% of fatty acid soaps obtained from coconut (lauric fats). The soap bars comprise at least 25 wt % lauric acid soaps, balance of non-lauric soaps having an iodine value (IV) of less than 45 and at least 5 wt % mildness actives.

US2019016994 A1 (Univ of Alabama) discloses sheets of soap that contain a polymer matrix comprising a first polymer, a polysaccharide homogenously distributed within the polymer matrix, and a fatty acid. The soap sheet is user friendly.

WO9928429 A1 (Bush Boake Allen) discloses soap bars containing a gel prepared from a hydrocarbon and a polymeric gellant.

WO2011080101 A1 (Unilever) discloses low TFM soap bars having a continuous phase substantially free of water-soluble builder. This phase contains 20% to 50% TFM, where unsaturated fatty acid soap is less than 39% by weight of the fatty acid soap. The bars have a structuring system comprising 10 to 45 wt % polysaccharide structurant selected from the group consisting of starch, cellulose and 6 to 30 wt % polyol selected from the group consisting of glycerol and sorbitol. The bars contain 0.5 to less than 3% anti-cracking agent which is carboxymethylcellulose, polyacrylate polymers and 10 to 20% water.

US2011077186 A1 (J&J) discloses low TFM soap bars containing a solid phase soap base and hydrogel phase particles dispersed in it to act as fillers and reduce the TFM and addresses the need for low TFM soap bars with an increased amount of water or fillers. The bars contain hydrogel fillers which is a coreless composite and preferably includes polyols or powders. The constituent materials remain separate and distinct on a macroscopic level within the finished structure and such hydrogel phase in the soap structure leads to new soaps and new soap-making processes. The hydrogel is said to be a gel which contains water but is not soluble in water. For example, when water is put on top of a hydrogel, the hydrogel and the water are clearly separated into two phases. The hydrogel is prepared externally in a pre-mixer and then mixed with soap noodles.

KR1020090010344 A (LG Household, 2009) discloses soap compositions that contain 0.5 to 60 wt % hydrated polysaccharide gel (alginate, pectin, gellan, carrageenan), 5 to 80 wt % water, 1 to 20 wt % fatty acid soap. The pre-prepared gel is mixed with fatty acids at the time of neutralization.

An object of the present invention is to prepare soap bars with high iodine value oils or fatty acids whilst still retaining at least one essential property of hardness, mush, rate of wear or cracking.

Unexpectedly, we have determined that inclusion of a hydrogel which is non-thermoreversible at 70 to 140° C. in a soap composition (such as noodles and bars) comprising saponified fatty matter made from a fat blend having iodine value 44 to 58 g/Iodine per 100 g improves some properties of the soap composition.

### SUMMARY OF THE INVENTION

In according with a first aspect disclosed is a soap composition comprising:
i) saponified fatty matter made from a fat blend comprising lauric fatty acid and saturated and unsaturated non-lauric fatty acids; and,
ii) a hydrogel which is non-thermoreversible at 70 to 140° C.; preferably wherein the hydrogel does not become a flowable liquid again when heated beyond the elevated temperature in the range of 70 to 140° C.
wherein iodine value of said saponified fatty matter is from 44 to 58 g/Iodine per 100 g of said saponified fatty matter.

In accordance with a second aspect disclosed is a process of preparing a soap composition comprising the steps of:
i) heating to 60 to 80° C., a fat blend comprising lauric fatty acid and saturated and unsaturated non-lauric fatty acids in a blend tank, where iodine value of said fat blend is from 44 to 58 g/Iodine per 100 g;
ii) adding at least one reactant from a first group of reactants consisting of a water soluble poly carboxylic acid, a water-soluble salt of such acid, calcium chloride, a borate or OHC(CH₂)nCHO, where n=2 to 6, while maintaining the temperature at 60 to 80° C.;
iii) adding an alkali to saponify the fat blend; and,
iv) adding at least one of a second group of reactants consisting of a polyol, alkaline silicate or a cellulose derivative for in-situ generation of said hydrogel by chemical cross-linking of functional groups of said first group of reactants with the corresponding reactive functional groups of said second group of reactants, wherein the temperature is maintained within the range of 90 to 110° C., and where said steps (ii) and (iv) may be interchanged.

Further disclosed is a process of preparing a soap composition comprising the steps of:
i) heating to 60 to 80° C., a fat blend comprising lauric fatty acid and saturated and unsaturated non-lauric fatty acids in a blend tank, where iodine value of said fat blend is from 44 to 58 g/Iodine per 100 g;
ii) adding an alkali to saponify the fat blend; and,
iii) adding a hydrogel to the saponified mass of step (ii) prepared by mixing at least one reactant from a first group of reactants consisting of a water soluble poly carboxylic acid, a water-soluble salt of such acid, calcium chloride, a borate or OHC(CH₂)nCHO, where n=2 to 6, with at least one of a second group of reactants consisting of a polyol, alkaline silicate or a cellulose derivative, where after addition of said hydrogel the temperature is maintained within the range of 90 to 110° C.

The term non-thermoreversible as applied to hydrogel refers to a hydrogel that is non flowable within the range of 70 to 140° C. and where the hydrogel does not become a flowable liquid again when heated beyond the elevated temperature.

Reference to the term “hydrogel solution” refers to a solution or dispersion or colloidal solution in which more than 90% of the hydrogel has been dissolved or is in colloidal form.

As used herein the term “comprising” encompasses the terms “consisting essentially of” and “consisting of”. Where the term “comprising” is used, the listed steps or options need not be exhaustive. Unless otherwise specified, numerical ranges expressed in the format “from x to y” are understood to include x and y. In specifying any range of values or amounts, any particular upper value or amount can be associated with any particular lower value or amount. Except in the examples and comparative experiments, or where otherwise explicitly indicated, all numbers are to be understood as modified by the word “about”. All percentages and ratios contained herein are calculated by weight unless otherwise indicated. As used herein, the indefinite article “a” or “an” and its corresponding definite article “the” means at least one, or one or more, unless specified otherwise. The various features of the present invention referred to in individual sections above apply, as appropriate, to other sections mutatis mutandis. Consequently, features specified in one section may be combined with features specified in other sections as appropriate. Any section headings are added only for convenience and are not intended to limit the disclosure in any way. The invention is not limited to the embodiments illustrated in the drawings. Accordingly it should be understood that where features mentioned in the claims are followed by reference numerals, such numerals are included solely for the purpose of enhancing the intelligibility of the claims and are in no way limiting to the scope of the claims.

Various components of the composition are described in greater detail below.

### DETAILED DESCRIPTION OF THE INVENTION

The composition of the invention comprises:
i) saponified fatty matter made from a fat blend comprising lauric fatty acid and saturated and unsaturated non-lauric fatty acids; and,
ii) a hydrogel which is non-thermoreversible at 70 to 140° C.
wherein iodine value of said saponified fatty matter is from 44 to 58 g/Iodine per 100 g of said saponified fatty matter.

Iodine value is an indicator of unsaturation and there are well known methods of measurement of IV. One method is gas chromatography. In this method, methyl esters of the fatty acids are formed and analysed by the chromatographic technique. In addition, there are wet chemical methods of analyses.

It is possible to measure iodine value of a fat blend before saponification. Additionally, it is possible to determine the iodine value of a soap (saponified oil or fatty acids) present in a finished good like a bar of soap or noodles of soap.

It is preferred that iodine value of the saponified fatty matter is 46 to 56 g/Iodine per 100 g of the saponified fatty matter, more preferably 48 to 52 g/Iodine per 100 g.

An expression called total fatty matter is used very widely in the field of soaps and detergents. The term abbreviated to “TFM”, is used to denote the wt % of fatty acid and triglyceride residues present in the soap composition without taking into account the accompanying cations. For a soap having 18 carbon atoms, an accompanying sodium cation will generally amount to about 8 wt %. Other cations may be employed as desired, for example zinc, potassium, magnesium, alkyl ammonium and aluminium.

It is preferred that the composition of the invention comprises 40 to 80 wt % TFM, more preferably 40 to 72 wt % TFM.

The term soap means salts of fatty acids in which the accompanying cation may be an alkali metal, alkaline earth metal or ammonium ion, preferably an alkali metal. Preferably, the cation is sodium or potassium. The soap may be saturated or unsaturated and it depends on the nature of the corresponding fatty acid and/or oil used for saponification.

It is preferred that the fat blend comprises 10 to 20 parts by weight lauric fatty acid, 35 to 50 parts by weight saturated non-lauric fatty acids and 20 to 45 parts by weight unsaturated non-lauric fatty acids, where the sum total of all fatty acids is 100 parts by weight.

Lauric fatty acid means acids derived, e.g. from coconut or palm kernel oil and comprising C12, i.e. lauric acid but may contain minor amounts, of up to 5 wt %, of shorter or longer-chain fatty acids, e.g., C10 to C14. Preferably the lauric fatty acid is derived from coconut or palm kernel oil.

Saturated non-lauric fatty acids means those fatty acids that are of higher carbon chain length than C14 and saturated. It is preferred that saturated non-lauric fatty acids comprising at least one of palmitic, myristic or stearic acid. Such fatty acids may comprise up to 2 to 3 wt % of other longer or shorter chain fatty acids, e.g., C20.

Unsaturated non-lauric fatty acids means those fatty acids that are unsaturated and of carbon chain length higher than C₁₂. It is preferred that unsaturated non-lauric fatty acids comprise one or more of oleic, linoleic, palmitoleic or linolenic acid. Such fatty acids may comprise up to 2 to 3 wt % of other longer or shorter chain fatty acids, e.g., C₂₀ or C₈. It is preferred that unsaturated non-lauric fatty acids are procured from at least one of tallow, lard, soya bean, sunflower, rice bran, linseed, olive, rapeseed, ground nut or fish oil. A variety of other alternative sources such as bioengineered oils may be employed.

Commercially available blends which may be used, with appropriate modifications or additional oils/fats, include 80/20, 85/15 blends where the lager number represents parts by weight of non-lauric fatty acids the smaller number represents the parts by weight of the lauric fatty acid.

The composition according to the invention comprises 0.2 to 5 wt % hydrogel, more preferably 0.4 to 2.5 wt % hydrogel. Hydrogels are the crosslinked networks of hydrophilic water-soluble polymers. They have tendency to absorb enormous amount of water and swell.

It is preferred that the hydrogel is a crosslinked reaction product of at least one of a first group of reactants and at least one of a second group of reactants:
(a) where the first group of reactants consists of a water soluble poly carboxylic acid, a water-soluble salt of such acid, calcium chloride, a borate and OHC(CH₂)nCHO where n=2 to 6; and,
(b) said second group of reactants consists of a polyol, alkaline silicate and a cellulose derivative.

When the reactant from the first group is a water soluble poly carboxylic acid or a water-soluble salt of such acid, the acid preferably is citric, glutaric or tartaric acid. When the reactant is a salt is preferably is a sodium or potassium salt.

When the reactant from the first group is a borate it preferably is sodium tetraborate decahydrate, calcium borate, calcium magnesium borate, sodium borate, boric acid or a mixture thereof.

Alternatively when the reactant from the first group is a compound of the formula OHC(CH₂)nCHO where n=2 to 6, it is preferred that n=3 and the compound is glutaraldehyde.

Without being bound by theory it is believed that when the reactants from the aforesaid two groups are allowed to react in the course of soap making, there is an in-situ generation of the non-thermoreversible hydrogel by chemical cross-linking of functional groups of a reactant from the first group of reactants with the functional groups of a reactant from the second group of reactants.

The second group of reactants consists of a polyol, alkaline silicate and a cellulose derivative.

Polyol is used herein to designate a compound having multiple hydroxyl groups (at least two, preferably at least three) which is highly water soluble, preferably freely soluble, in water. Many types of polyols are available such as relatively low molecular weight short chain polyhydroxy compounds such as glycerol and propylene glycol; sugars such as sorbitol, manitol, sucrose and glucose; modified carbohydrates such as hydrolyzed starch, dextrin and maltodextrin, and polymeric synthetic polyols such as polyalkylene glycols, for example polyoxyethylene glycol (PEG) and polyoxypropylene glycol (PPG). Preferred polyols are relatively low molecular weight compound which are either liquid or readily form stable highly concentrated aqueous solutions, e.g., greater that 50% and preferably 70% or greater by weight in water. These include low molecular weight polyols and sugars. When the reactant is a polyol it preferably is polyethylene glycol, propylene glycol, glycerol or sorbitol.

When the reactant from the second group of reactants is a cellulose derivative it preferably is microcrystalline cellulose such as AVICEL® GP 1030, or a hydroxyalkyl alkyl cellulose ether. Alternatively, the preferred cellulose derivative is cellulose ether selected from alkyl celluloses, hydroxyalkyl celluloses and carboxyalkyl celluloses. More preferably it is hydroxyalkyl celluloses or carboxyalkyl celluloses. Preferred hydroxyalkyl cellulose includes hydroxymethyl cellulose, hydroxyethyl cellulose, hydroxypropyl cellulose and ethyl hydroxyethyl cellulose. Preferred carboxyalkyl cellulose includes carboxymethyl cellulose. It is particularly preferred that the carboxymethyl cellulose is sodium carboxymethyl cellulose.

Sodium carboxymethylcellulose (SCMC) is a derivative of cellulose formed by its reaction with alkali and chloroacetic acid. Carboxymethylcellulose (CMC) is biodegradable derivative of cellulose, which is considered ideal for preparing hydrogels due to its high swelling ability.

Alternatively, the reactant from the second group of reactants is alkaline silicate. It preferably is in powdered, solution or slurry form. Preferably the alkaline silicate is sodium silicate. It is preferred that in the alkaline silicate the molar ratio of SiO2:Na2O is in the range of 1 to 4, more preferably 1.5 to 2.5, most preferably 2.

Without being bound by theory, a mechanism of crosslinking reactions leading to the formation of a hydrogel is provided below using citric acid and sodium carboxymethyl cellulose as exemplary reactants from each of the two group.

This hydrogel is formed due to crosslinking by way of esterification. At sufficiently high temperature, citric acid forms a cyclic anhydride and esterifies the hydroxyl groups present on the adjacent polymer chains. This leads to the formation of crosslinks which generally occur under dry state and require high temperature. Esterification of —OH functional groups of the polysaccharide with the cyclic anhydride intermediate leads to the hydrogel.

It is particularly preferred that when the reactant from the first group of reactants is a water-soluble poly carboxylic acid or a water-soluble salt of such acid, the corresponding reactant from the second group of reactants is a cellulose derivative. In particular, it is preferred that when the water-soluble poly carboxylic acid is citric acid, the water-soluble salt of such acid is sodium citrate that the cellulose derivative is SCMC.

Alternatively, it is preferred that when the reactant from the first group is a water-soluble poly carboxylic acid or a water-soluble salt of such acid, the corresponding reactant from the second group of reactants is alkaline silicate. In particular it is preferred that the water-soluble poly carboxylic acid is citric acid, the water-soluble salt of such acid is sodium citrate and the alkaline silicate is sodium silicate.

Further, alternatively, it is preferred that when the reactant from the first group of reactants is a OHC(CH₂)nCHO where n=2 to 6, the corresponding reactant from the second group of reactants is a polyol. In particular it is preferred that OHC(CH₂)nCHO is glutaraldehyde, the polyol is glycerol or sorbitol or polyethylene glycol.

Form and Format

The soap composition of the invention could be in any physical form. It preferably is in the form of noodles, sheets, flakes, chips or powder, more preferably noodles.

The term “noodles” is used to refer to generally cylindrical particles prepared by extrusion and cutting or breaking noodles generally containing soap as a major ingredient.

Noodles based on soap are commonly produced by mixing dried soap chips with colourants and other minor ingredients, homogenising by working in either a mill or a refiner, and then extruding through a perforated plate with fine holes. They are generally extruded continuously and then allowed to weather sufficiently to break up into pieces from 3 to 15 mm in length. A series of rotating knives can be fitted to the face of the plate to cut the extruded noodles automatically into suitable lengths, but these tend to cause a certain amount of bunching to take place. The degree of bunching depends on the geometry of the cutting knives and holes and is also greatly affected by the plasticity and stickiness of the noodles themselves. Even where a rotating knife is not used, the quality of the noodles is dependent on the physical properties of the extruded soap. Ideally, the soap should be sufficiently plastic to extrude satisfactorily through the holes in the perforated plate but not so soft and sticky that they bunch together after extrusion. They should also be sufficiently hard and brittle to break up into the desired length range.

While noodles of soap can be used for washing and cleaning purposes, practically such noodles are used as input or raw material for making bars or tablets of soap which are sold in shops and supermarkets and are used by consumers as a personal wash composition.

Therefore, in accordance with another aspect of the invention, disclosed is a bar of soap comprising a soap composition of the first aspect of the invention. The bar may be of any shape and size, but preferably is rectangular with rounded edges and of a size that allows it to be held comfortably in one hand.

Other Ingredients

In addition to the saponified fatty matter and the hydrogel, the soap composition of the invention, example noodles, and in particular the bars of soap, preferably comprises one or more of the following other ingredients. Choice of the ingredients and the amounts thereof are largely dependant on the formulation scientists and the purpose for which such noodles or bars are made.

Non-Soap Surfactant

The composition of the invention preferably includes a non-soap surfactant, which acts as a co-surfactant and which is selected from anionic, non-ionic, zwitterionic, amphoteric or cationic surfactant. Preferably the composition comprises 0.1 to 15 wt % non-soap surfactant. More preferably the composition comprises 2 to 10 wt % non-soap surfactant and most preferably 3 to 6 wt %.

Suitable anionic surfactants include water soluble salts of organic sulphuric reaction products having in the molecular structure an alkyl radical containing from 8 to 22 carbon atoms, and a radical chosen from sulphonic acid or sulphuric acid ester radicals, and mixtures thereof.

Examples of suitable anionic surfactants are sodium and potassium alcohol sulphates, especially those obtained by sulphating the higher alcohols produced by reducing the glycerides of tallow or coconut oil; sodium and potassium alkyl benzene sulphonates such as those in which the alkyl group contains from 9 to 15 carbon atoms; sodium alkyl glyceryl ether sulphates, especially those ethers of the higher alcohols derived from tallow and coconut oil; sodium coconut oil fatty acid monoglyceride sulphates; sodium and potassium salts of sulphuric acid esters of the reaction product of one mole of a higher fatty alcohol and from 1 to 6 moles of ethylene oxide; sodium and potassium salts of alkyl phenol ethylene oxide ether sulphate with from 1 to 8 units of ethylene oxide molecule and in which the alkyl radicals contain from 4 to 14 carbon atoms; the reaction product of fatty acids esterified with isethionic acid and neutralized with sodium hydroxide where, for example, the fatty acids are derived from coconut oil and mixtures thereof.

The preferred water-soluble synthetic anionic surfactants are the alkali metal (such as sodium and potassium) and alkaline earth metal (such as calcium and magnesium) salts of higher alkyl benzene sulphonates and mixtures with olefin sulphonates and higher alkyl sulphates, and the higher fatty acid monoglyceride sulphates. Suitable nonionic surfactants can be broadly described as compounds produced by the condensation of alkylene oxide groups, which are hydrophilic in nature, with an organic hydrophobic compound which may be aliphatic or alkyl aromatic in nature. The length of the hydrophilic or polyoxyalkylene radical which is condensed with any particular hydrophobic group can be readily adjusted to yield a water-soluble compound having the desired degree of balance between hydrophilic and hydrophobic elements.

Particular examples include the condensation product of aliphatic alcohols having from 8 to 22 carbon atoms in either straight or branched chain configuration with ethylene oxide, such as a coconut oil ethylene oxide condensate having from 2 to 15 moles of ethylene oxide per mole of coconut alcohol; condensates of alkylphenols whose alkyl group contains from 6 to 12 carbon atoms with 5 to 25 moles of ethylene oxide per mole of alkylphenol; condensates of the reaction product of ethylenediamine and propylene oxide with ethylene oxide, the condensate containing from 40 to 80 percent of polyoxyethylene radicals by weight and having a molecular weight of from 5,000 to 11,000; tertiary amine oxides of structure R3NO, where one group R is an alkyl group of 8 to 18 carbon atoms and the others are each methyl, ethyl or hydroxyethyl groups, for instance dimethyldodecylamine oxide; tertiary phosphine oxides of structure R3PO, where one group R is an alkyl group of from 10 to 18 carbon atoms, and the others are each alkyl or hydroxyalkyl groups of 1 to 3 carbon atoms, for instance dimethyldodecylphosphine oxide; and dialkyl sulphoxides of structure R2SO where the group R is an alkyl group of from 10 to 18 carbon atoms and the other is methyl or ethyl, for instance methyltetradecyl sulphoxide; fatty acid alkylolamides; alkylene oxide condensates of fatty acid alkylolamides and alkyl mercaptans.

Suitable cationic surfactants that can be incorporated are alkyl substituted quarternary ammonium halide salts e.g. bis (hydrogenated tallow) dimethylammonium chlorides, cetyltrimethyl ammonium bromide, benzalkonium chlorides and dodecylmethylpolyoxyethylene ammonium chloride and amine and imidazoline salts for e.g. primary, secondary and tertiary amine hydrochlorides and imidazoline hydrochlorides.

Suitable amphoteric surfactants are derivatives of aliphatic secondary and tertiary amines containing an alkyl group of 8 to 18 carbon atoms and an aliphatic radical substituted by an anionic water-solubilising group, for instance sodium 3-dodecylamino-propionate, sodium 3-dodecylaminopropane sulphonate and sodium N-2-hydroxydodecyl-N-methyltaurate.

Suitable zwitterionic surfactants are derivatives of aliphatic quaternary ammonium, sulphonium and phosphonium compounds having an aliphatic radical of from 8 to 18 carbon atoms and an aliphatic radical substituted by an anionic water-solubilising group, for instance 3-(N—N-dimethyl-N-hexadecylammonium) propane-1-sulphonate betaine, 3-(dodecylmethyl sulphonium) propane-1-sulphonate betaine and 3-(cetylmethylphosphonium) ethane sulphonate betaine.

Further examples of suitable detergent-active compounds are compounds commonly used as surface-active agents given in the well-known textbooks “Surface Active Agents”, Volume I by Schwartz and Perry and “Surface Active Agents and Detergents”, Volume Il by Schwartz, Perry and Berch.

Electrolyte

Inclusion of small amount of an electrolyte (other than soap) can influence the liquid and solid phase ratio. Increasing the electrolyte content lowers the solubility of soap thereby increasing the solid phase amount, on the other hand lowering the electrolyte levels make the bars softer.

It is preferred that composition of the invention comprises 1 to 20 wt %, more preferably in the range of 2 to 15 wt % electrolyte, and most preferably 3 to 10% by weight of the composition. Preferred electrolytes include sodium sulfate, sodium chloride, sodium citrate, potassium chloride, potassium sulfate, sodium carbonate and other mono or di or tri salts of alkaline earth metals, more preferred electrolytes are sodium chloride, sodium sulfate, potassium chloride and especially preferred electrolytes are sodium chloride and sodium sulfate and combinations thereof. For the avoidance of doubt is clarified that the electrolyte is a non-soap material.

Opacifier

An opacifier may be optionally present in the composition. When opacifiers are present, the cleansing bar is generally opaque, i.e. “opacification”. Examples of opacifiers include titanium dioxide, zinc oxide and the like. A particularly preferred opacifier that can be employed when an opaque rather than a transparent soap composition is desired is ethylene glycol mono- or di-stearate, for example in the form of a 20% solution in sodium lauryl ether sulphate. An alternative opacifying agent is zinc stearate.

Benefit Agents

Preferably the soap composition of the invention comprises one or more benefit agent not already disclosed earlier. Preferably the benefit agent is an emollient, sunscreen, anti-ageing compounds or moisturizers and humectants. The agents may be added at an appropriate step during the process. Some benefit agents may be introduced as macro domains.

Examples of moisturizers and humectants include cetyl alcohol, ethoxylated castor oil, paraffin oils, lanolin and its derivatives. Silicone compounds such as silicone surfactants like DC® 3225C (Dow Corning) and/or silicone emollients, silicone oil (DC-200® ex. Dow Corning) may also be included. Further examples include glycerin, oat kernel flour, Petrolatum, Aquaporin manipulation and hydroxyethyl urea.

Sunscreens such as 4-tertiary butyl-4′-methoxy dibenzoylmethane (available under the trade name PARSOL®1789 from Givaudan) or 2-ethyl hexyl methoxy cinnamate (available under the trade name PARSOL® MCX from Givaudan) or other UV-A and UV-B sun-screens may also be added. Further examples include Helioplex® (Diethylhexyl naphthylate), Ensulizole®, Ethylhexyl salicylate, Tinosorb® (S & M), Octocrylene® and Mexoryl®.

Lipids such as cholesterol, ceramides, and pseudoceramides, and exfoliant particles such as polyethylene beads, walnut shells, apricot seeds, flower petals and seeds may also be present. Structurants such as maltodextrin or starch may be used to structure the bars.

The composition can also optionally include other ingredients conventionally used in soap such as lather boosters, colourants and opacifiers and skin tone agents such as hexyl resorcinol, Soybean extract (Bowman Birk inhibitor), Octadecenedioic acid, (Arlatone® DC), niacinamide, Seppiwhite®, Acetylglucosamine, Pitera Extract, Symwhite® and Melano-block® (Calcium pantothenate). Further, the composition of the invention may comprise antiaging ingredient such as retinol, hyaluronic acid, Collagen, CoQ10 (ubiquinone), retinyl propionate, peptides, retinyl palmitate, Jasmonic acid derivatives and Proxylane®.

Other adjunct materials may include germicides and preservatives. These ingredients normally will be in amounts less than 2 wt %, usually less than 0.5 wt % and may include silver salts and silver compounds, thymol, terpineol and their analogues, ZPTO, chloroxylenol, PCMX, triclosan and trichlorocarbanilide.

The soap composition may include structurants. These may include water insoluble particulate material. Structurants may, individually or combined, support 0 to 25 wt %. Preferred inorganic particulate material includes talc and calcium carbonate. Talc is a magnesium silicate mineral material, with a sheet silicate structure represented by the chemical formula Mg₃Si₄(O)₁₀(OH)₂ and may be available in the hydrated form. Talc has a plate-like morphology and is substantially oleophilic/hydrophobic.

Examples of other optional insoluble inorganic particulate materials include zeolites aluminates, silicates, phosphates, insoluble sulfates, clays (e.g., kaolin, china clay), titanium oxide, zinc oxide and their combinations.

The compositions of the invention may additionally comprise anti-cracking agents such as acrylate polymers.

The term “slip modifier” is used herein to designate materials that when present at relatively low levels (generally less than 1.5% based on the total weight of the bar composition) will significantly reduce the perceived friction between the wet bar and the skin. The most suitable slip modifiers are useful, individually or combined, at a level of 1% or less, preferably from 0.05 to 1% and more preferably from 0.05 to 0.5%.

Suitable slip modifier include petrolatum, waxes, lanolins, poly-alkane, poly-alkene, polyalkyene oxides, high molecular weight polyethylene oxide resins, silicones, polyethylene glycols and mixtures thereof.

Free fatty acids (FFA) up to 3% such as coconut fatty acid, PKO fatty acid, lauric acid are commonly used in soap bars for overall quality and process improvement. Free fatty acid higher than 3% could lead to soft and sticky mass and could negatively impact one or more physical feature. In at least one form, level of FFA in compositions of the invention is 0.05 to 3%, preferably 0.1 to 2%, more preferably 0.1 to 1.5 wt %.

A variety of test method have been used to determine properties of the soap compositions.

The test methods are hardness testing protocol, using a 30° conical probe which penetrates to depth of 15 mm. Another test is the rate of wear (RoW) which relates to the amount of material which is lost by a soap bar product under controlled conditions. These conditions for use, mimic approximately the way consumers use the product. A further test is done to check for the extent of as the physical damage which may result (or not) from the sequence of washdown and drying of the bar. Yet another test is to determine “mush” defined as the jelly, creamy material that forms when toilet soap bars absorb water. The Mush Immersion Test gives a numerical value of the amount of mush formed on a bar.

All the aforesaid test methods have been described in US20190016994 A1 (Unilever).

Process of the Invention

The process of the invention comprises the first step of heating to 60 to 80° C., a fat blend comprising lauric fatty acid and saturated and unsaturated non-lauric fatty acids in a blend tank, where iodine value of the fat blend is from 44 to 58 g/Iodine per 100 g. The main parts of a typical mixer are a jacketed barrel, axial rotating shaft through the centre of the barrel (longitudinally), plough-shaped blades mounted on the axial shaft, and chopper. The ploughs and the high-speed chopper are the mixing elements. Since the gap between the plough surface and the barrel is about 3 to 8 mm, the material gets sheared significantly while mixing. A typical mixer has barrel volume of 60 litres, plough rpm of 200 and chopper rpm of 3000. The plough area to barrel volume is approximately 0.002 cm⁻¹.

About a third of the blend from the melting tank is then transferred into the blend tank maintained at 60 to 80° C.

The process may be alternatively be carried out in any mixer conventionally used in soap manufacture. Preferably a high shear kneading mixer is used. The preferred mixers include kneading members of sigma type, multi wiping overlap, single curve or double arm. The double arm kneading mixers can be of overlapping or tangential in design. Alternatively, the invention can be carried out in a helical screw agitator vessel or multi head dosing pump/high shear mixer and spray drier combinations as in conventional processing.

The next step involves adding at least one reactant from a first group of reactants consisting of a water soluble poly carboxylic acid, a water-soluble salt of such acid, calcium chloride, a borate or OHC(CH₂)nCHO, where n=2 to 6, while maintaining the temperature at 60 to 80° C.

The third step involves adding an alkali, preferably under shearing action, to saponify the fat blend. The saponification is preferably carried out to the extent of 80 to 100%. Preferably an aqueous solution or dispersion of the alkali is used. More preferably the alkali is caustic soda. Alternatively, any other suitable alkali may be used in stoichiometric amount which can be calculated easily. Temperature of the reaction mass increases due to exothermic nature of the saponification reaction. Preferably a portion of the total alkali is introduced into the mixer in an aqueous form.

The next step involves, under shearing action, adding at least one of a second group of reactants consisting of a polyol, alkaline silicate or a cellulose derivative for in-situ generation of said hydrogel by chemical cross-linking of functional groups of said first group of reactants with the corresponding reactive functional groups of said second group of reactants, wherein the temperature is maintained within the range of 90 to 110° C., and where the steps (ii) and (iv) may be interchanged. It is preferred that the at least one of a second group of reactants is added after complete saponification of the fat blend.

Preferably a sample is tested to check the extent of saponification by using an indictor such as phenolphthalein. The extent of saponification (neutralisation) can also be checked periodically using a pH paper, pH meter or any other suitable device or techniques known in the art.

Preferably the fat blend comprises 10 to 20 parts by weight lauric fatty acid, 35 to 50 parts by weight saturated non-lauric fatty acids and 20 to 45 parts by weight unsaturated non-lauric fatty acids, where the sum total of all fatty acids is 100 parts by weight. Preferably the unsaturated non-lauric fatty acids are obtained from at least one of tallow, lard, soya bean, sunflower, rice bran, linseed, olive, rapeseed, ground nut or fish oil such that iodine value of said fat blend is from 44 to 58 g/Iodine per 100 g of said blend.

Further disclosed is a process of preparing a soap composition comprising the steps of:
i) heating to 60 to 80° C., a fat blend comprising lauric fatty acid and saturated and unsaturated non-lauric fatty acids in a blend tank, where iodine value of said fat blend is from 44 to 58 g/Iodine per 100 g;
ii) adding an alkali to saponify the fat blend; and,
iii) adding a hydrogel to the saponified mass of step (ii) prepared by mixing at least one reactant from a first group of reactants consisting of a water soluble poly carboxylic acid, a water-soluble salt of such acid, calcium chloride, a borate or OHC(CH₂)nCHO, where n=2 to 6, with at least one of a second group of reactants consisting of a polyol, alkaline silicate or a cellulose derivative, where after addition of said hydrogel the temperature is maintained within the range of 90 to 110° C.

In this alternative process, the hydrogel is prepared separately and it is blended or mixed with the saponified mass.

The following examples illustrate the invention with non-limiting embodiments.

### EXAMPLES

A range of soap compositions (noodles) were prepared in a plough shear mixer, with different combination of reactants forming the hydrogel as disclosed further.

A weighed amount of hot (60-65° C.) blend having desired Iodine value, were added in a melting tank. About one third of the molten blend was transferred into Plough Shear Mixer (PSM) and temperature of the PSM was maintained at 80° C. The applicable weighed amount of aqueous solution of a first of the ingredients forming hydrogel was added to the PSM. This was followed by addition of aqueous caustic soda followed by ⅓ amount of total glycerin and shearing action was applied. This step was repeated and, in this manner, the full amount of the blend, caustic soda and glycerin was added. A sample was tested to check the extent of saponification. Thereafter, the chelating agents were added followed by an aqueous solution of the second of the ingredients forming hydrogel and the contents were thoroughly mixed. The composition was passed through a noodler to get soap noodles.

The TFM was 70 wt %. The formulations are shown in Table 1.

TABLE 1

| | wt % | | | | |
|---|---|---|---|---|---|
| | Composition Code | | | | |
| Ingredient | C1 | C2 | 1 | 2 | 3 |
| IV | 40 | 48 | 48 | 48 | 48 |
| Lauric acid | 10.0 | 10.0 | 10.0 | 10.0 | 10.0 |
| Distilled non-lauric | 63.0 | 52.0 | 52.0 | 52.0 | 52.0 |
| fatty acids | | | | | |
| Sunflower oil | — | 8.5 | 8.5 | 8.5 | 8.5 |
| NaCl | 0.75 | 0.75 | 0.8 | 0.75 | 0.75 |
| NaOH | 11.3 | 10.9 | 10.9 | 10.9 | 10.9 |
| Glycerine | 2.0 | 2.0 | 2.0 | 2.0 | 2.0 |
| Sodium citrate | — | — | 0.48 | 0.35 | 0.55 |
| Sodium silicate | — | — | 1.25 | — | — |
| SCMC* | — | — | — | 0.06 | 0.06 |
| Water and other | 100.0 | 100.0 | 100.0 | 100.0 | 100.0 |
| minors to | | | | | |

Further details about the fat blends/saponified fatty matter (including the IV) are as follows:
C1: IV 40
C2: IV 48
1: IV 48
2: IV 48
3: IV 48

The Iodine value of the fat blends/saponified fatty matter was measured by the standard Wij's method. Iodine Value As used herein the term “iodine value” is used as a generic term for the measure of the unsaturation of oil and is expressed in terms of the number of centigrammes of iodine absorbed per gramme of sample (% iodine absorbed). The higher the iodine number, the more unsaturated double bonds are present in oil and hence the more prone the oil is to oxidisation via the double bond. Iodine value is determined using the Wijs Method as provided in the American Oil Chemists' Society (AOCS) Official Method Tg 1a-64, pages 1-2, Official Methods and Recommended Practices of the American Oil Chemists' Society, Second Edition, edited by D. Firestone, AOCS Press; Champaign, 1990, method Revised 1990).

The noodles of Example 1 were used to prepare corresponding soap bars. For example, noodles of composition C1 were used to prepare soap bars of composition C1B and so on. Details of the soap bar compositions are shown in Table 2.

TABLE 2

| | wt % | | | | |
|---|---|---|---|---|---|
| | Composition Code | | | | |
| Ingredient | C1B | C2B | 1B | 2B | 3B |
| Noodles of Example 1 | 95.0 | 95.0 | 95.0 | 95.0 | 95.0 |
| Lauric acid as free fatty acid | 0.2 | 0.2 | 0.2 | 0.2 | 0.2 |
| Talc | 2.5 | 2.5 | 2.5 | 2.5 | 2.5 |
| Titanium oxide | 0.5 | 0.5 | 0.5 | 0.5 | 0.5 |
| Other minors to | 100.0 | 100.0 | 100.0 | 100.0 | 100.0 |

The soap bars of Table 2 were subjected to some tests according to the methods described earlier. The soap composition of C2B was soft and mushy and was not tested for further parameters. The observations are summarised in table 3.

TABLE 3

Composition Code

| Test parameter | C1B | 1B | 2B | 3B |
|---|---|---|---|---|
| IV of fat blend | 40 | 48 | 48 | 48 |
| Hardness | 4620 | 4303 | 4129 | 4597 |
| Mush g/50 cm² | 10.4 | 8.8 | 10.5 | 10.4 |

The data indicates that, as compared with the bars devoid of the hydrogel and not made in accordance with the process of the invention, the bars 1B, 2B and 3B were almost as hard, despite the use of high IV oil/fat in the composition. Further, while the bars 1B produced less mush than the control bars of example C1B, the mush in case of bars 2B and 3B was again the same, or almost the same as control bars of example C1B. The illustrated examples clearly indicates that the compositions in accordance with the invention allows preparation of soap bars using high iodine value oils or fatty acids whilst still retaining essential properties of hardness and mush.

1. A soap composition comprising:
i) saponified fatty matter made from a fat blend comprising lauric fatty acid and saturated and unsaturated non-lauric fatty acids; and,
ii) a hydrogel which is non-thermoreversible at 70 to 140° C.;
wherein iodine value of said saponified fatty matter is from 44 to 58 g of iodine per 100 g of said saponified fatty matter, as determined by the Wiis Method;
wherein the hydrogel is a crosslinked reaction product of at least one of a water-soluble Poly carboxylic acid or a water-soluble salt of such acid, with a cellulose derivative;
and wherein the soap composition comprises 40 to 72 wt % total fatty matter.

2. The soap composition as claimed in claim 1, wherein the iodine value is 46 to 56 g of iodine per 100 g of the saponified fatty matter, as determined by the Wiis Method.

3. (canceled)

4. The soap composition as claimed in claim 1, wherein the soap composition is a milled soap composition.

5. The soap composition as claimed in claim 1, wherein the fat blend comprises 10 to 20 parts by weight lauric fatty acid, 35 to 50 parts by weight saturated non-lauric fatty acids and 20 to 45 parts by weight unsaturated non-lauric fatty acids, where the sum total of all fatty acids is 100 parts by weight.

6. The soap composition as claimed in claim 1, wherein said composition comprises 0.2 to 5 wt % hydrogel.

7. (canceled)

8. The soap composition as claimed in claim 1, wherein said saturated non-lauric fatty acids comprise at least one of palmitic, myristic or stearic acid.

9. The soap composition as claimed in claim 1, wherein said unsaturated non-lauric fatty acids comprise one or more of oleic, linoleic, palmitoleic or linolenic acid.

10. The soap composition as claimed in claim 9, wherein said unsaturated non-lauric fatty acids are obtained from at least one of tallow, lard, soya bean, sunflower, rice bran, linseed, olive, rapeseed, ground nut or fish oil.

11. The soap composition as claimed in claim 1, wherein said lauric fatty acid is derived from coconut or palm kernel oil.

12. The soap composition as claimed in claim 1, wherein said composition is in the form of noodles, flakes, chips or powder.

13. A bar of soap comprising the soap composition as claimed in claim 1.

14. A process of preparing a soap composition as claimed in claim 1 comprising the steps of:
i) heating to 60 to 80° C., a fat blend comprising lauric fatty acid and saturated and unsaturated non-lauric fatty acids in a blend tank, where iodine value of said fat blend is from 46 to 58 g of iodine per 100 g, as determined by the Wiis Method;
ii) adding a water-soluble poly carboxylic acid, or a water-soluble salt of such acid, while maintaining the temperature at 60 to 80° C.;
iii) adding an alkali to saponify the fat blend; and,
iv) adding a cellulose derivative for in-situ generation of said hydrogel by chemical cross-linking of functional groups of the water-soluble Poly carboxylic acid, or a water-soluble salt of such acid with the corresponding reactive functional groups of the cellulose derivative, wherein the temperature is maintained within the range of 90 to 110° C., and where steps (ii) and (iv) may be interchanged.

15. A process of preparing a soap composition as claimed in claim 1 comprising the steps of:
i) heating to 60 to 80° C., a fat blend comprising lauric fatty acid and saturated and unsaturated non-lauric fatty acids in a blend tank, where iodine value of said fat blend is from 46 to 58 g of iodine per 100 q, as determined by the Wiis Method;
ii) adding an alkali to saponify the fat blend; and,
iii) adding a hydrogel to the saponified mass of step (ii) prepared by mixing at least one of a water-soluble poly carboxylic acid, or a water-soluble salt of such acid, with a cellulose derivative, where after addition of said hydrogel the temperature is maintained within the range of 90 to 110° C.
